(19) United States
(12) Patent Application Publication
(10) Pub. No.: US 2024/0346722 A1
(43) Pub. Date: Oct. 17, 2024

(54) IMAGE GENERATING APPARATUS, DEEP LEARNING TRAINING METHOD, AND STORAGE MEDIUM STORING INSTRUCTIONS TO PERFORM THUMBNAIL GENERATING METHOD

(71) Applicant: POSTECH RESEARCH AND BUSINESS DEVELOPMENT FOUNDATION, Pohang-si (KR)

(72) Inventors: Taehyun OH, Pohang-si (KR); Hyunwoo HA, Pohang-si (KR); Sungbin KIM, Pohang-si (KR)

(73) Assignee: POSTECH RESEARCH AND BUSINESS DEVELOPMENT FOUNDATION, Pohang-si (KR)

(21) Appl. No.: 18/423,226

(22) Filed: Jan. 25, 2024

(30) Foreign Application Priority Data
Apr. 17, 2023 (KR) 10-2023-0050310
Aug. 1, 2023 (KR) 10-2023-0100634

(51) Int. Cl. G06T 11/60; G06V 10/44

(52) U.S. Cl. CPC G06T 11/60; G06V 10/44

(57) ABSTRACT

There is provided a method for training an image generating model that generates an image from an audio. The method includes selecting at least one frame from a video including a plurality of frames based on a correlation between an audio and an image of each frame; extracting image information and audio information from each of the selected at least one frame; and training an audio feature vector extracting model that extracts an audio feature vector from the audio information, wherein the audio feature vector is aligned within an embedding space with an image feature vector extracted from the image information by a pre-trained image feature vector extracting model.

### CROSS-REFERENCE TO RELATED APPLICATIONS

This application claims the benefit of and priority to Korean Patent Application No. 10-2023-0050310 filed on Apr. 17, 2023 and Korean Patent Application No. 10-2023-0100634 filed on Aug. 1, 2023, the entirety of each of which is incorporated herein by reference for all purposes.

### TECHNICAL FIELD

The present disclosure relates to an image generating apparatus and a deep learning training method.

### BACKGROUND

The field of cross-modal generation between audio and images is researched in two directions: generating audio from images and generating images from audio. Generating audio from images has been actively researched from the perspective of musical instruments, music, and open-domain general audio generation. In contrast, generating images from audio has been researched to specific limited audio domains, and there is also a problem in that the quality of the generated images is not high.

Previous research on cross-modal generation, which translates one modality into another modality, has been conducted in various domains, including translating text into images or videos, translating audio into faces or gestures, and translating images or audio into captions, etc. To connect heterogeneous modalities in cross-modal generation, existing pre-trained models are used, or pre-trained CLIP embedding space is extended and adjusted to fit the text-image modality.

There is existing research on manipulating images using audio where a text-based image modifying model is used and extended to the audio-image modality to expand the embedding space. Similarly, conditional generative adversarial networks have been used to modify the visual style of images to match audio, thereby adjusting the volume of audio, or manipulating images by mixing multiple audio sources. However, these methods are limited to manipulating the style of images, and they require a text-based embedding space.

### SUMMARY

According to embodiments of the present disclosure, to solve the problems of prior arts that handle limited types of audios or require images to be input together with audios when generating images from the audios, an image generating apparatus and a training method that are different from prior arts, which generates images from audios regardless of the type of audios, or modifies images by inputting both images and audios, or generates separate objects corresponding to audios, etc. are proposed.

However, the problems to be solved by the present disclosure are not limited to those mentioned above, and other problems not mentioned above will be clearly understood by those skilled in the art, where the present disclosure belongs, from the following description. In accordance with an aspect of the present disclosure, there is provided a method for training an image generating model that generates an image from an audio, the method comprises: selecting at least one frame from a video including a plurality of frames based on a correlation between an audio and an image of each frame; extracting image information and audio information from each of the selected at least one frame; and training an audio feature vector extracting model that extracts an audio feature vector from the audio information, wherein the audio feature vector is aligned within an embedding space with an image feature vector extracted from the image information by a pre-trained image feature vector extracting model.

The selecting the at least one frame may include selecting the at least one frame from the video using a frame selection method.

The method may comprise inputting the audio feature vector into an image generator configured to generate the image based on the image feature vector; and providing the image generated by the image generator.

The training the audio feature vector extracting model may be performed by a contrastive learning method.

The contrastive learning method may include InfoNCE (noise contrastive estimation).

In accordance with another aspect of the present disclosure, there is provided an image generating apparatus, the apparatus comprises: an input unit configured to receive a first audio; a memory configured to store computer-executable instructions, an audio feature vector extracting model, and an image feature vector extracting model including an image generator; and a processor configured to execute the one or more instructions stored in the memory, wherein the instructions, when executed by the processor, cause the processor to extract a first audio feature vector from a first audio using the audio feature vector extracting model, and generate a first image based on the first audio feature vector using the image generator, wherein the audio feature vector extracting model is trained to extract, when at least one frame is selected from a video including a plurality of frames based on a correlation between an audio and an image of each frame, and a second image and a second audio are extracted from each of the selected at least one frame, a second audio feature vector from the second audio, wherein the second audio feature vector is aligned within an embedding space with a second image feature vector extracted from the second image by a pre-trained image feature vector extracting model, and wherein the image generator is pre-trained to generate the second image based on the second image feature vector.

The first audio may be different from the second audio.

The first image may be generated, when a volume level of the first audio is changed, by reflecting the changed volume level.

The input unit may be configured to receive the first audio or a third image and input the first audio and the third image to the image generator, and the image generator may be configured to generate a fourth image in which the first image is reflected onto the third image.

The fourth image may be generated by adding a new object corresponding to the first audio onto the third image.

The fourth image may be generated by modifying the third image, corresponding to the first audio.

The fourth image may be generated, when a volume level of the first audio changes, by reflecting the changed volume level.

The first audio may include a plurality of audio sources originated respectively from a plurality of entities, and the first image may include each sub-image corresponding to each entity included in the plurality of entities, respectively.

The first image may be generated, when respective volume levels corresponding to a plurality of audio sources included in the first audio relatively is changed to each other, by reflecting the relatively changed respective volume levels.

The processor may be configured to control a video generator to generate a video based on the first image, the input unit may be configured to receive the first audio or a first video and input the first audio and the first video to the video generator, and the video generator may be configured to generate a second video from a second plurality of images generated by adding a new object corresponding to the first audio based on a first plurality of images included in the first video.

The processor may be configured to control a video generator to generate a video based on the first image, the input unit may be configured to receive the first audio or a first video and input the first audio and the first video to the video generator, and the video generator is configured to generate a second video, if a volume level of the first audio changes, from a second plurality of images generated by reflecting the changed volume level based on a first plurality of images included in the first video.

In accordance with another aspect of the present disclosure, there is provided a non-transitory computer-readable recording medium storing a computer program, which comprises instructions for a processor to perform a thumbnail generating method, the thumbnail generating method comprise: inputting an audio data; extracting at least one audio information at predetermined time intervals in the audio data; extracting at least one audio feature vector by inputting the extracted at least one audio information into a pre-trained audio feature vector extracting model; and generating at least one thumbnail by inputting the audio feature vector into an image generator trained to generate an image based on an image feature vector extracted by a pre-trained image feature vector extracting model from image information corresponding to the audio information, wherein the audio feature vector is aligned within an embedding space with the image feature vector.

The thumbnail generating method may comprise classifying the at least one audio feature vectors into clusters; and determining a representative audio feature vector for each cluster, wherein the generating the thumbnail may include inputting the representative audio feature vector into the image generator and determining the thumbnail generated by the image generator.

The generating the at least one thumbnail may include generating a plurality of thumbnails and outputting the plurality of generated thumbnails sequentially.

The generating the at least one thumbnail may include generating a plurality of thumbnails, selecting a final thumbnail from the plurality of generated thumbnails, and outputting a final thumbnail.

An image generating method according to an embodiment of the present disclosure may modify images to correspond to audios or generate images reflecting audios based on images by inputting the audios.

It may also be used as a content creation tool for generating new images corresponding to audios.

Furthermore, it may train models using unlabeled audio-image pairs and generate images corresponding to the audios regardless of a text-based image-language embedding space.

The effects achievable from the present disclosure are not limited to the effects described above, and other effects not mentioned above will be clearly understood by those skilled in the art, where the present disclosure belongs, from the following description.

### BRIEF DESCRIPTION OF THE DRAWINGS

FIG. 1 is a diagram illustrating a training apparatus for an image generating model 100 according to an embodiment of the present disclosure.

FIG. 2 is a diagram illustrating a control unit 130 included in a training apparatus for an image generating model 100 according to an embodiment of the present disclosure.

FIG. 3 is a flowchart illustrating a training method for an image generating model according to an embodiment of the present disclosure.

FIG. 4 is a flowchart illustrating an image generating method after being trained according to a training method for an image generating model according to an embodiment of the present disclosure.

FIG. 5 is a diagram illustrating an image generating apparatus 200 according to an embodiment of the present disclosure.

FIG. 6 is a diagram illustrating an image generating apparatus 300 according to another embodiment of the present disclosure.

FIG. 7 is a diagram illustrating a system implementing an image generating method according to an embodiment of the present disclosure.

FIG. 8 is a diagram illustrating a concept of a frame selection method according to an embodiment of the present disclosure.

FIG. 9 is a diagram illustrating input information that may be input according to an image generating method and images that may be generated based thereon according to an embodiment of the present disclosure.

FIG. 10 is a diagram illustrating a various of images generated by a various of audio circumstances according to an embodiment of the present disclosure.

FIG. 11 is a diagram conceptually illustrating a modification of a video by an image generating apparatus by reflecting changes in a volume level of an audio that is input with the video according to an embodiment of the present disclosure.

FIG. 12 is a diagram specifically illustrating a modification of videos by an image generating apparatus by reflecting changes in a volume level of audios that are input with the videos according to an embodiment of the present disclosure.

FIG. 13 is a flowchart illustrating a thumbnail generating method according to an embodiment of the present disclosure.

FIG. 14 is a flowchart illustrating a thumbnail generating method according to another embodiment of the present disclosure.

FIG. 15 is a diagram illustrating a thumbnail generating method according to an embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

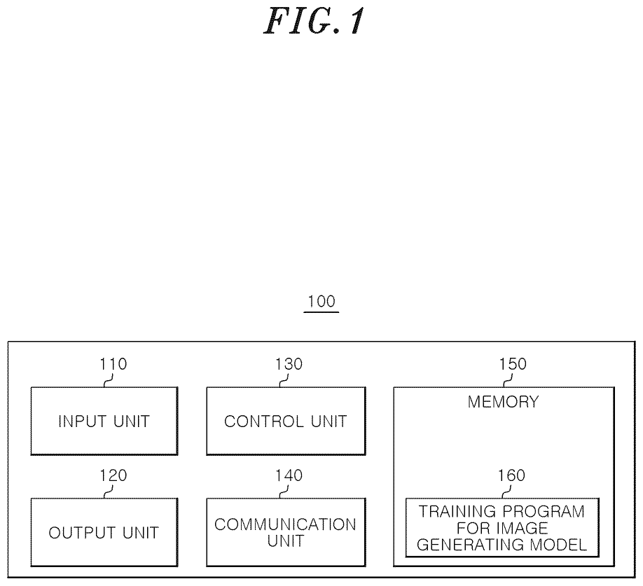

FIG. 1 is a diagram illustrating a training apparatus for an image generating model 100 according to an embodiment of the present disclosure.

As illustrated in FIG. 1, the training apparatus for an image generating model 100 may include an input unit 110, a control unit 130, and a memory 150, and may further include an output unit 120 or a communication unit 140 optionally.

The input unit 110 may receive image information, audio information, or video information for training of the image generating model.

The input unit 110 may receive image information, audio information, or video information for generating images.

The input unit 110 may provide the received information to the control unit 130.

The input unit 110 may include an input interface capable of receiving information for training of the image generating model or information for generating images, or a communication module capable of receiving it through a communication network.

The method by which the input unit 110 receives the information for training the image generating model or the information for generating images may vary and is not limited to any specific means.

The output unit 120 may display generated images or videos as visual information through a user interface or a display means.

The output unit 120 may include an output interface capable of outputting the generated images or videos, or a communication module capable of transmitting data through a communication network.

The method by which the output unit 120 displays the generated images or videos may vary and is not limited to any specific means.

The control unit 130 may be implemented by a processor, which may refer to a hardware-embedded data processing apparatus that is physically structured with circuits to perform functions represented by code or commands included in a program. The control unit 130 may include processors such as a microprocessor, a central processing unit (CPU), a processor core, a multiprocessor, an application-specific integrated circuit (ASIC), a field-programmable gate array (FPGA), and the like, but this is not limited to the embodiment mentioned above.

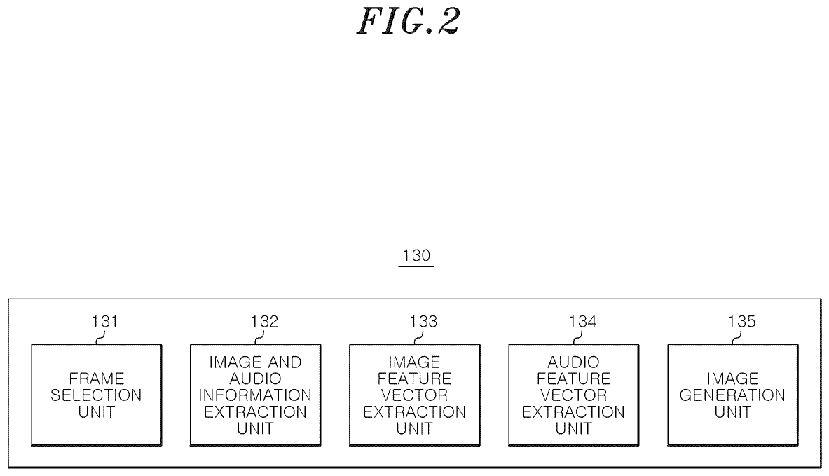

The control unit 130 may control execution of a training method for the image generating model, and a detailed description thereof will be given in FIG. 2.

The control unit 130 may control the communication unit 140 to transmit and receive information for training of the image generating model, information for generating images, or information including the generated images or videos. The communication unit 140 may be a wireless communication module capable of performing wireless communication by adopting communication methods such as CDMA, GSM, W-CDMA, TD-SCDMA, WiBro, LTE, EPC, wireless LAN, Wi-Fi, Bluetooth, Zigbee, Wi-Fi Direct (WFD), Ultra-Wideband (UWB), Infrared Data Association (IrDA), Bluetooth Low Energy (BLE), or Near Field Communication (NFC), but is not limited to the embodiment mentioned above.

Information for training of the image generating model and information for generating images may be received through the communication unit 140 or be directly received by using an internal device. In addition, information including the generated images or videos may be transmitted through the communication unit 140 or be directly transmitted by using an internal device. The method by which the information for training of the image generating model, the information for generating images, and the information including the generated images or videos are received or transmitted is not limited to the embodiment mentioned above.

The memory 150 may store a training program for image generating model 160, information for execution of the training program for image generating model 160, and processing results by the control unit 130.

The memory 150 may store the information for training of the image generating model, the information for generating images, and the information including the generated images or videos. Herein, the image generating model may include an audio feature extracting model, an image feature extracting model, and image generator.

The memory 150 may refer to computer-readable media, for example, specially configured hardware devices to store and execute program commands such as magnetic media (e.g., a hard disk, a floppy disk, and a magnetic tape), optical media (e.g., a CD-ROM and a DVD), magneto-optical media (e.g., a floptical disk), and flash memory, but this is not limited to the embodiment mentioned above.

FIG. 2 is a diagram illustrating a control unit 130 included in a training apparatus for an image generating model 100 according to an embodiment of the present disclosure.

As illustrated in FIG. 2, the control unit 130 may include a frame selection unit 131, an image and audio information extraction unit 132, an image feature vector extraction unit 133, an audio feature vector extraction unit 134, and an image generation unit 135.

According to an embodiment of the present disclosure, the control unit 130 may control execution of a training method for an image generating model, which includes the steps of selecting at least one frame from multiple frames in a video based on a correlation between an audio and an image in each frame, extracting image information and audio information from the selected at least one frame, and training an audio feature vector extracting model that extracts an audio feature vector from the audio information.

The frame selection unit 131 may select at least one frame from a video including multiple frames based on a correlation between an audio and an image in each frame. Selecting a frame based on the correlation between an audio and an image means selecting a frame that includes highly correlated audio information and image information within the video. In order to select a frame, a frame selection method may be used.

The image and audio information extraction unit 132 may extract image information and audio information from the selected at least one frame from a video including multiple frames. Since a frame is selected based on the correlation between an audio and an image of each frame, highly correlated audio information and image information may be extracted from the video.

The image feature vector extraction unit 133 may extract, by inputting image information, a corresponding image feature vector.

The image feature vector extraction unit 133 may extract a corresponding image feature vector by inputting image information extracted from each of at least one frame selected from a video including multiple frames.

The image feature vector extraction unit 133 may include a pre-trained image feature vector extracting model that extracts a corresponding image feature vector by inputting image information extracted from each of the at least one frame selected from a video including multiple frames. Self-supervised learning may be used as a method of training the image feature vector extracting model.

The audio feature vector extraction unit 134 may extract, by inputting audio information, a corresponding audio feature vector.

The audio feature vector extraction unit 134 may extract a corresponding audio feature vector by inputting audio information extracted from each of the at least one frame selected from a video including multiple frames.

Herein, the audio feature vector may have been aligned within an embedding space with the image feature vector extracted from image information by the image feature vector extracting model.

The audio feature vector extraction unit 134 may be trained to align an image feature vector extracted from image information by the image feature vector extraction unit 133 with an audio feature vector extracted from audio information by the audio feature vector extraction unit 134 within an embedding space. Because of the high correlation between the audio information and the image information that are extracted from a video, the audio feature vector extraction unit 134 may extract an audio feature vector that is aligned with an image feature vector, and then the extracted audio feature vector may be input to the image generation unit 135 to generate, simply by inputting the audio feature vector, an image that is equivalent or similar to an image generated by inputting an image feature vector.

Within an embedding space defined by heterogeneous modalities, to align spaces for an image feature vector Z^{V} and an audio feature vector Z^{A}, a method that minimizes a distance ∥Z^{V}−Z^{A}∥₂ (eg, a loss L₂) between the two vectors may be used.

Within an embedding space defined by heterogeneous modalities, the InfoNCE as shown in the following Equation 1 may be used as a contrastive learning method to align an image feature vector Z^{V} and an audio feature vector Z^{A}.

$$InfoNCE ( {a}_{j} , {\{ b \}}_{k = 1}^{N} ) = - log \frac{exp ( - d ( {a}_{j} , {b}_{j} ) )}{{\sum }_{k = 1}^{N} exp ( - d ( {a}_{j} , {b}_{k} ) )} \qquad [ Equation 1 ]$$

Herein, a and b represent arbitrary vectors in the same dimension, and d(a,b)=∥a−b∥₂. Using Equation 1, the audio feature vector extraction unit 134 may be trained to extract an audio feature vector that has a high similarity with an image feature vector. With the loss L₂, the image generation unit 135 may maximize the feature similarity between an image and its audio segment (positive) while minimizing the similarity with the randomly selected unrelated audios (negatives). Given the j-th image and audio feature pair, the image generation unit 135 may define audio feature-centric loss as L^{A}ⱼ=InfoNCE(\hat{ }z^{A}ⱼ, {\hat{ }z^{V}}), where \hat{ }z^{A} and \hat{ }z^{V} are representations with unit-norm. Also, the image generation unit 135 may calculate the image feature-centric loss term as L^{V}ⱼ=InfoNCE(\hat{ }z^{V}ⱼ, {\hat{ }z^{A}}). Then, the image generation unit 135 may minimize the sum of each loss term for all the audio and image pairs in the mini-batch B. After the image generation unit 135 trains the audio encoder with the loss L₂ as shown in the following Equation 2, the image generation unit 135 trains visually enriched audio features that are aligned with the image features.

$${L}_{total} = \frac{1}{2 B} {\sum }_{j = 1}^{B} ( {L}_{j}^{A} + {L}_{j}^{V} ) \qquad [ Equation 2 ]$$

The image generation unit 135 may generate, by inputting an image feature vector extracted by the image feature vector extraction unit 133, a corresponding image.

The image generation unit 135 may be pre-trained to generate, by inputting an image feature vector extracted by the image feature vector extraction unit 133, a corresponding image. The image generation unit 135 may include a conditional generative adversarial network. In addition, the image generation unit 135 may include a diffusion model. The conditional generative adversarial network or the diffusion model included in the image generation unit 135 may be pre-trained. Self-supervised learning may be used as a method to train the image generation unit 135, the conditional generative adversarial network, or the diffusion model. For example, the image generation unit 135 may calculate the contrastive loss L₂ as depicted in the Equation 2 above.

The image generation unit 135 may generate, by inputting an audio feature vector extracted by the audio feature vector extraction unit 134, a corresponding image.

Because highly correlated audio information and image information have been extracted from a video, the audio feature vector extraction unit 134 may extract an audio feature vector that is aligned with an image feature vector. Once the extracted audio feature vector is input to the image generation unit 135, an image that is equivalent or similar to an image generated by inputting an image feature vector may be generated simply by inputting the audio feature vector.

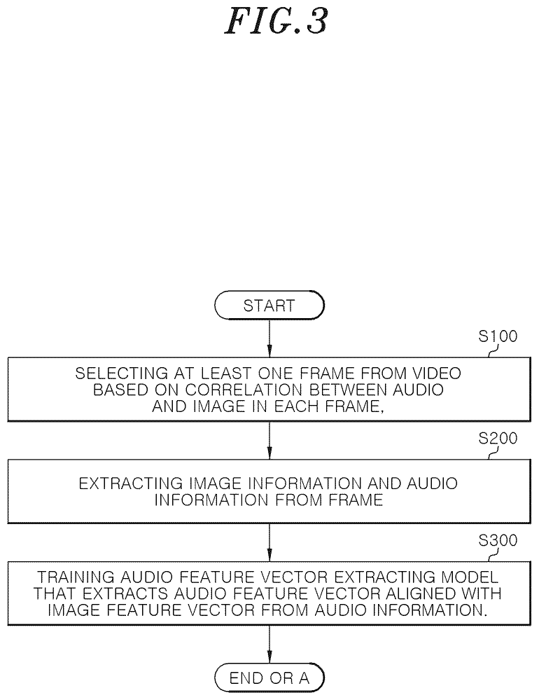

FIG. 3 is a flowchart illustrating a training method for an image generating model according to an embodiment of the present disclosure.

As illustrated in FIG. 3, the training method for an image generating model according to an embodiment includes a step S100 of selecting at least one frame from a video including multiple frames based on a correlation between the audio and image in each frame, a step S200 of extracting image information and audio information from the selected at least one frame, and a step S300 of training an audio feature vector extracting model that extracts an audio feature vector from the audio information.

Herein, the audio feature vector may be aligned with an image feature vector extracted from the image information by the training the image feature vector extracting model.

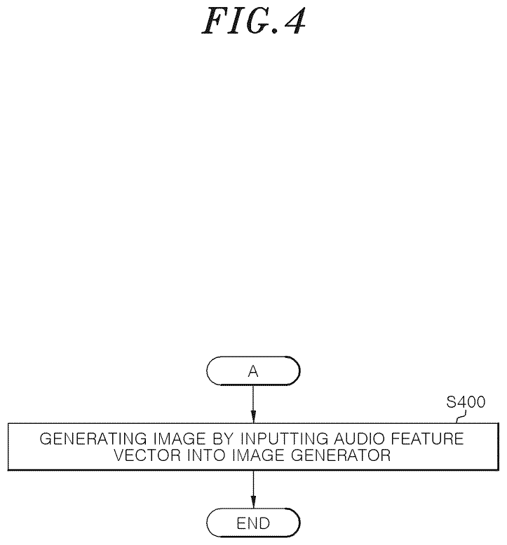

FIG. 4 is a flowchart illustrating an image generating method after being trained according to a training method for an image generating model according to an embodiment of the present disclosure.

As illustrated in FIG. 4, a training method for the image generating model according to an embodiment may further include a step S400 of generating an image by inputting an audio feature vector into an image generator that is pre-trained to generate an image based on an image feature vector.

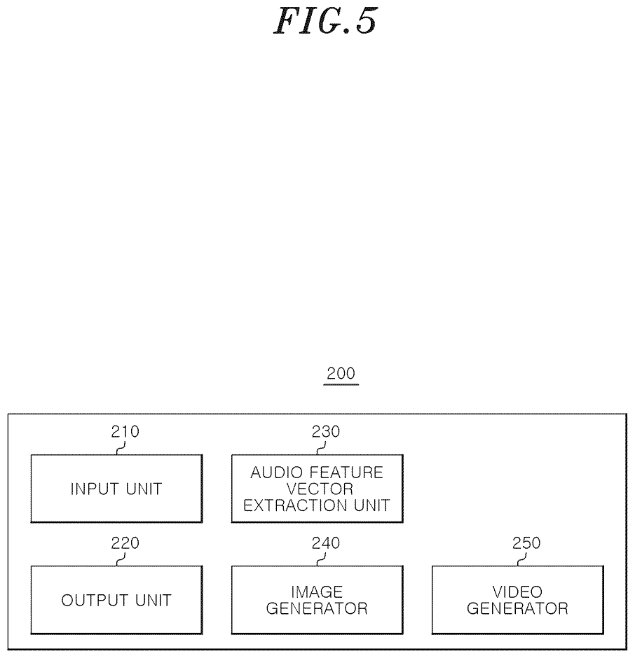

FIG. 5 is a diagram illustrating an image generating apparatus 200 according to an embodiment of the present disclosure.

As illustrated in FIG. 5, the image generating apparatus 200 according to an embodiment may include an input unit 210, an audio feature vector extraction unit 230, and an image generator 240, and may further include an output unit 220 optionally.

The input unit 210 may receive image information, audio information, or video information for training of an image generating model.

The input unit 210 may receive image information, audio information, or video information for generating images.

The input unit 210 may include an input interface capable of receiving information for training of the image generating model or information for generating images, or a communication module capable of receiving it through a communication network.

The method by which the input unit 210 receives the information for training the image generating model or the information for generating images may vary and is not limited to any specific means.

The output unit 220 may display generated images or videos as visual information through a user interface or a display means.

The output unit 220 may include an output interface capable of outputting the generated images or videos, or a communication module capable of transmitting data through a communication network.

The method by which the output unit 220 displays the generated images or videos may vary and is not limited to any specific means.

The audio feature vector extraction unit 230 may extract, by inputting audio information, a corresponding audio feature vector.

The audio feature vector extraction unit 230 may extract a corresponding audio feature vector by inputting audio information extracted from each of the at least one frame selected from a video including multiple frames.

Herein, the audio feature vector may have been aligned within an embedding space with the image feature vector extracted by inputting, into a pre-trained image feature vector extracting model, image information extracted from each of the at least one frame selected from a video including multiple frames.

The audio feature vector extraction unit 230 may be trained to align an image feature vector extracted from image information by a pre-trained image feature vector extracting model with an audio feature vector extracted from audio information by the audio feature vector extraction unit 230 within an embedding space. Because of the high correlation between the audio information and the image information that are extracted from a video, the audio feature vector extraction unit 230 may extract an audio feature vector that is aligned with an image feature vector, and then the extracted audio feature vector may be input to the image generator 240 to generate, simply by inputting the audio feature vector, an image that is equivalent or similar to an image generated by inputting an image feature vector.

Within an embedding space defined by different modalities, to align an image feature vector Z^{V} and an audio feature vector Z^{A}, a method that minimizes the distance ∥Z^{V}−Z^{A}∥₂ between the two vectors may be used.

Within an embedding space defined by different modalities, the InfoNCE as shown in the above Equation 1 may be used as a contrastive learning method to align an image feature vector Z^{V} and an audio feature vector Z^{A}.

The image generator 240 may be pre-trained to generate, by inputting an image feature vector extracted by a pre-trained image feature vector extracting model, a corresponding image. The image generator 240 may include a conditional generative adversarial network. In addition, the image generator 240 may include a diffusion model. The conditional generative adversarial network or the diffusion model included in the image generator 240 may be pre-trained. Self-supervised learning may be used as a method to train the image generator 240, the conditional generative adversarial network, or the diffusion model.

The image generator 240 may generate, by inputting an audio feature vector extracted by the audio feature vector extraction unit 230, a corresponding image.

Because highly correlated audio information and image information have been extracted from a video, the audio feature vector extraction unit 230 may extract an audio feature vector that is aligned with an image feature vector. Once the extracted audio feature vector is input to the image generator 240, an image that is equivalent or similar to an image generated by inputting an image feature vector may be generated simply by inputting the audio feature vector.

Referring back to FIG. 5, the image generating apparatus 200 according to an embodiment may include the input unit 210 that receives a first audio, the audio feature vector extraction unit 230 that extracts a first audio feature vector from the first audio, and the image generator 240 that generates a first image based on the first audio feature vector, and may further include the output unit 220 optionally.

Herein, the audio feature vector extraction unit 230 may be trained to extract a second audio feature vector from a second audio once at least one frame is selected from a video including multiple frames based on a correlation between an audio and an image of each frame and then a second image and the second audio are extracted from each of the selected at least one frame.

Herein, the second audio feature vector may have been aligned within an embedding space with a second image feature vector extracted from the second image by a pre-trained image feature vector extracting model.

Herein, the image generator 240 may be pre-trained to generate a second image based on the second image feature vector.

The first audio may be different from the second audio. Therefore, even if audio data that was not used in training is input to the trained model, a corresponding image may be output. This may indicate that model training may be performed without labeling.

If a volume level of the first audio changes, the first image may be generated by reflecting the changed volume level.

The input unit 210 may receive the first audio or a third image. The image generator 240 may generate when the first audio and the third image are input together, a fourth image in which the first image is reflected onto the third image.

The fourth image may have been generated by adding a new object corresponding to the first audio onto the third image.

The fourth image may have been generated by modifying the third image, corresponding to the first audio.

If a volume level of the first audio changes, the fourth image may be generated by reflecting the changed volume level.

The first audio may include a plurality of audio information with different frequency bands.

The first audio may include a plurality of audio sources originated from a plurality of entities, and the first image may include images corresponding to each entity of the multiple entities.

The fourth image may have been generated by adding a new object corresponding to the first audio onto the third image. Therefore, even if audio information mixed with another type of audio is input, distinguished objects may be displayed on the generated image without being mixed to each other.

The fourth image may have been generated by modifying the third image, corresponding to the first audio. Therefore, an image may be generated by reflecting input audio information based on input image information.

If a volume level of the first audio changes, the fourth image may be generated by reflecting the changed volume level.

The first audio may include a plurality of audio sources originated from a plurality of entities, and the first image may include images corresponding to each entity of the multiple entities.

If respective volume levels corresponding to a plurality of audio sources included in the first audio relatively change to each other, the first image may be generated by reflecting the relatively changed respective volume levels.

The image generating apparatus 200 according to an embodiment may include a video generator 250 that generates a video based on the first image.

Herein, the input unit 210 may receive the first audio or the first video.

The video generator 250 may generate a second video from a second plurality of images generated by adding a new object corresponding to the first audio based on a first plurality of images included in the first video.

If a volume level of the first audio changes, the video generator 250 may generate a second video from a second plurality of images generated by reflecting the changed volume level based on a first plurality of images included in the first video.

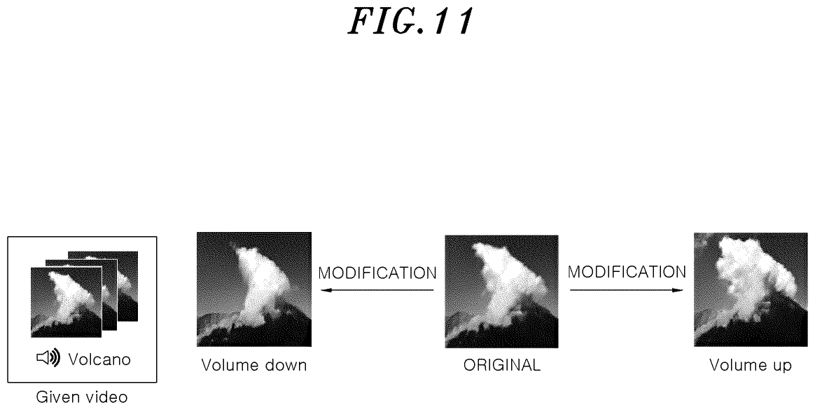

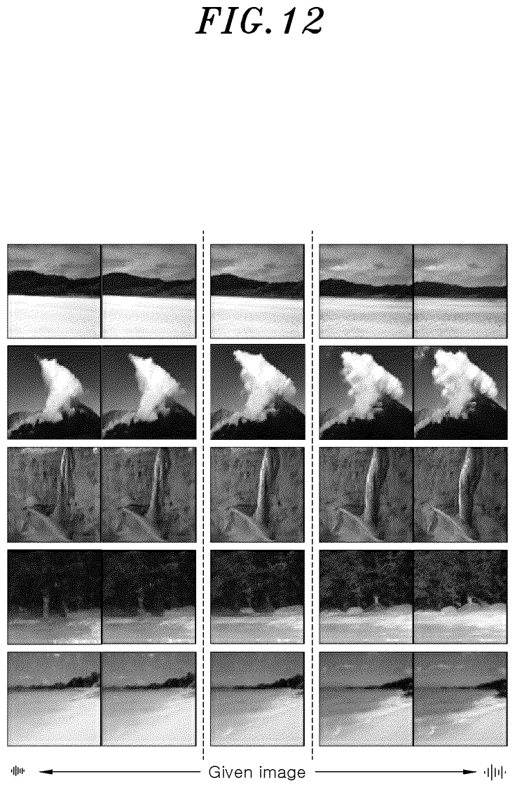

A method of modifying a video by reflecting audio information will be described in detail in FIGS. 11 and 12.

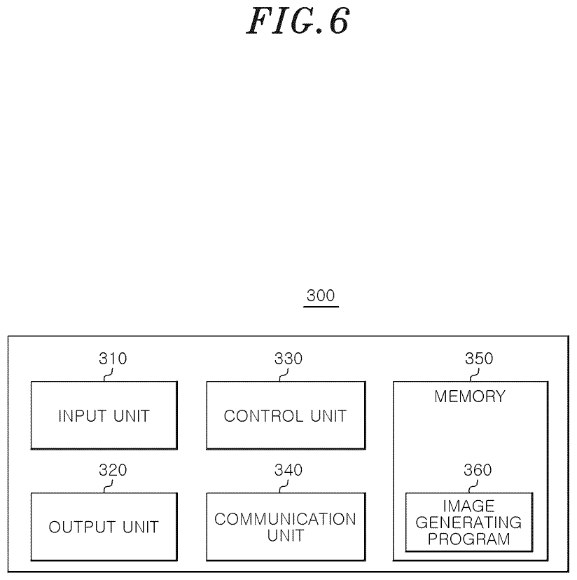

FIG. 6 is a diagram illustrating an image generating apparatus 300 according to another embodiment of the present disclosure.

As illustrated in FIG. 6, the image generating apparatus 300 according to an embodiment may include an input unit 310, a control unit 330, and a memory 350, and may further include an output unit 320 or a communication unit 340 optionally.

The input unit 310 may receive image information, audio information, or video information for training of the image generating model.

The input unit 310 may receive image information, audio information, or video information for generating images.

The input unit 310 may include an input interface capable of receiving information for training of the image generating model or information for generating images, or a communication module capable of receiving it through a communication network.

The method by which the input unit 310 receives the information for training the image generating model or the information for generating images may vary and is not limited to any specific means.

The output unit 320 may display generated images or videos as visual information through a user interface or a display means.

The output unit 320 may include an output interface capable of outputting the generated images or videos, or a communication module capable of transmitting data through a communication network.

The method by which the output unit 320 displays the generated images or videos may vary and is not limited to any specific means.

The control unit 330 may indicate a processor, or a hardware-embedded data processing apparatus that is physically structured with circuits to perform functions represented by code or commands included in a program. The control unit 330 may include processors such as a microprocessor, a central processing unit (CPU), a processor core, a multiprocessor, an application-specific integrated circuit (ASIC), a field-programmable gate array (FPGA), and the like, but this is not limited to the embodiment mentioned above.

The control unit 330 may control execution of an image generating method according to an embodiment.

The control unit 330 may control the communication unit 340 to transmit and receive information for training of the image generating model, information for generating images, or information including the generated images or videos. The communication unit 340 may be a wireless communication module capable of performing wireless communication by adopting communication methods such as CDMA, GSM, W-CDMA, TD-SCDMA, WiBro, LTE, EPC, wireless LAN, Wi-Fi, Bluetooth, Zigbee, Wi-Fi Direct (WFD), Ultra-Wideband (UWB), Infrared Data Association (IrDA), Bluetooth Low Energy (BLE), or Near Field Communication (NFC), but is not limited to the embodiment mentioned above.

Information for training of the image generating model and information for generating images may be received through the communication unit 340 or be directly received by using an internal device. In addition, information including the generated images or videos may be transmitted through the communication unit 340 or be directly transmitted by using an internal device. The method by which the information for training of the image generating model, the information for generating images, and the information including the generated images or videos are received or transmitted is not limited to the embodiment mentioned above.

The memory 350 may store an image generating program 360, information for execution of the image generating program 360, and processing results by the control unit 330.

The memory 350 may store the information for training of the image generating model, the information for generating images, and the information including the generated images or videos.

The memory 350 may refer to computer-readable media, for example, specially configured hardware devices to store and execute program commands such as magnetic media (e.g., a hard disk, a floppy disk, and a magnetic tape), optical media (e.g., a CD-ROM and a DVD), magneto-optical media (e.g., a floptical disk), and flash memory, but this is not limited to the embodiment mentioned above.

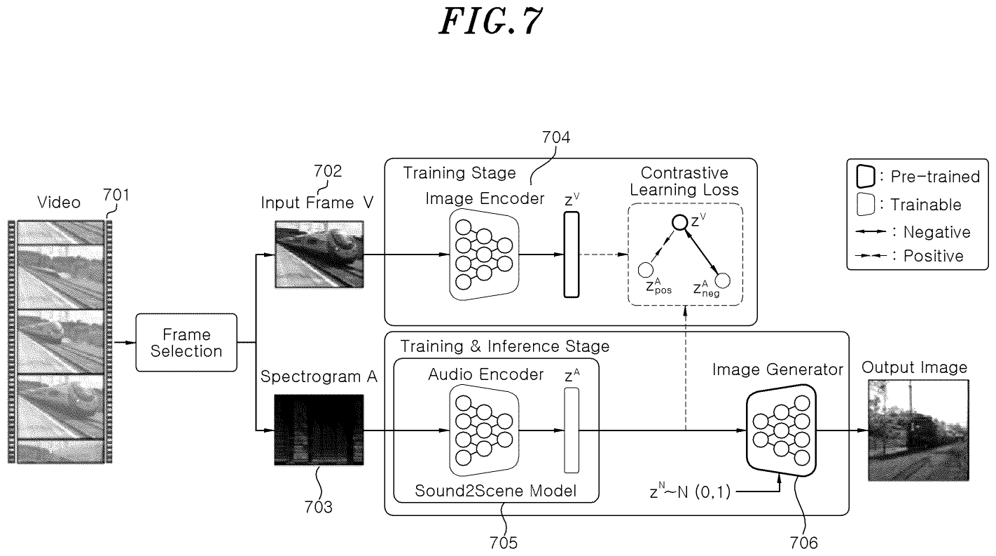

FIG. 7 is a diagram illustrating a system implementing an image generating method according to an embodiment of the present disclosure.

First, at least one frame may be selected from a video 701 including a plurality of frames based on a correlation between an audio and an image in each frame. Selecting a frame based on the correlation between an audio and an image means selecting a frame that includes highly correlated audio information and image information within the video. In order to select a frame, a frame selection method may be used.

Thereafter, image information 702 and audio information 703 may be extracted from the selected at least one frame from the video including multiple frames. Since the frame is selected based on the correlation between an audio and an image of each frame, highly correlated audio information 703 and image information 702 may be extracted from the video 701.

Thereafter, an image feature vector extracting model 704 may be pre-trained to extract a corresponding image feature vector by inputting, into the image feature vector extracting model 704, image information 702 extracted from each of at least one frame selected from a video 701 including multiple frames.

Thereafter, by inputting an image feature vector extracted by an image feature vector extracting model 704, the image feature vector extracting model 704 may be pre-trained to generate a corresponding image.

Thereafter, the audio feature vector extracting model 705 may be trained to align an image feature vector extracted from image information 702 by the image feature vector extracting model 704 with an audio feature vector extracted from audio information 703 by an audio feature vector extracting model 705 within an embedding space. Because of the high correlation between the audio information 703 and the image information 702 that are extracted from the video 701, the audio feature vector extracting model 705 may extract an audio feature vector that is aligned with the image feature vector, and then the extracted audio feature vector may be input to an image generator 706 to generate, simply by inputting the audio feature vector, an image that is equivalent or similar to an image generated by inputting an image feature vector.

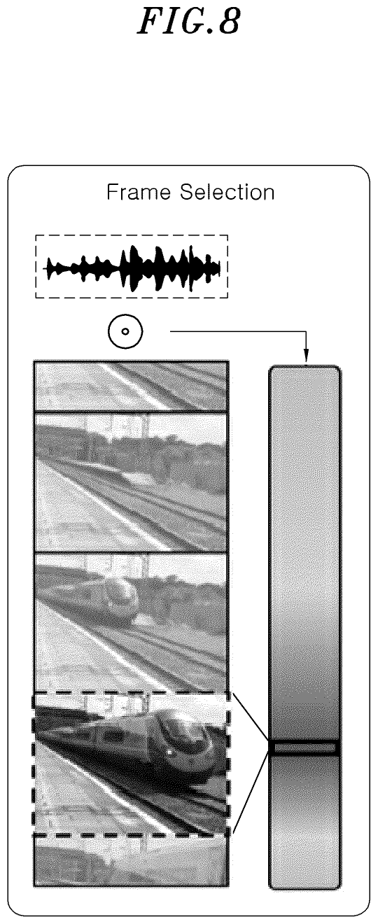

FIG. 8 is a diagram illustrating a concept of a frame selection method according to an embodiment of the present disclosure.

The frame selection method may be used to select, from a video including a plurality of frames, at least one frame including a highly correlated pair of audio information and image information based on a correlation between the audio and image in each frame.

As illustrated in FIG. 8, in a video including image information of a train, a frame including a train image corresponding to a train audio may be selected based on image information with a high correlation with audio information including the train audio.

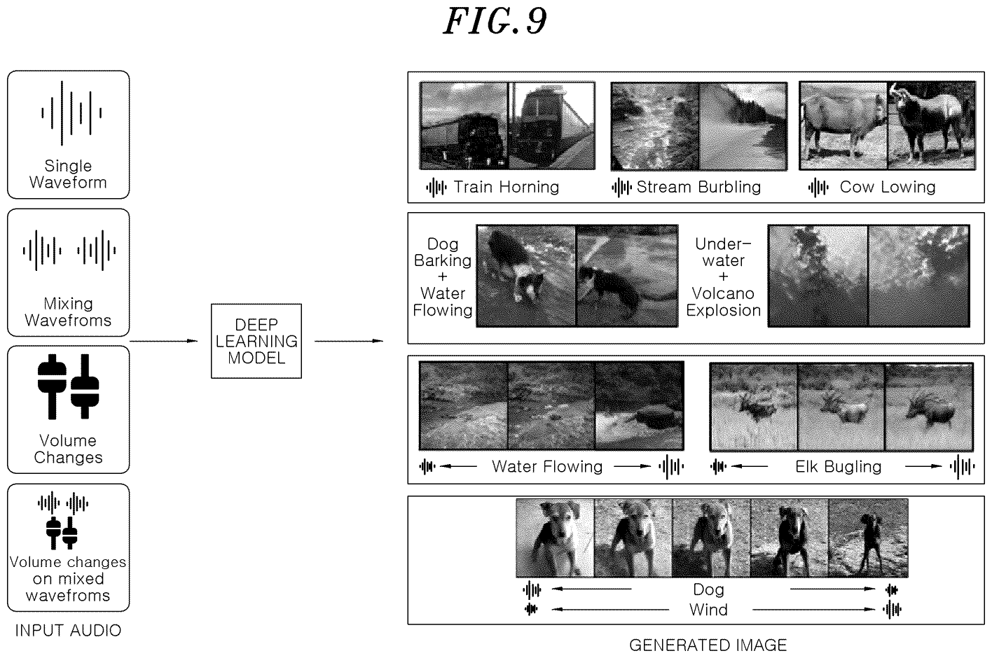

FIG. 9 is a diagram illustrating input information that may be input according to an image generating method and images that may be generated based thereon according to an embodiment of the present disclosure.

As illustrated in FIG. 9, an image may be generated by inputting various types of audio.

When single waveform information is input to an image generating apparatus according to an embodiment of the present disclosure, corresponding images may be generated.

When mixing waveforms information is input to an image generating apparatus according to an embodiment of the present disclosure, an image reflecting all of mixed audio information may be generated. For example, as illustrated in FIG. 9, if mixed audio information including a dog sound and a water sound is input into the image generating apparatus, an image including image information on both the dog and the water may be generated.

If a volume level of audio information input into the image generating apparatus according to an embodiment of the present disclosure changes, an image reflecting the changed volume level may be generated, maintaining image information on the same object. For example, as illustrated in FIG. 9, when the water sound becomes louder, an image with a stronger water flow may be generated, and when an elk sound becomes louder, an image with a larger elk may be generated.

In case of inputting mixing waveforms information into the image generating apparatus according to an embodiment of the present disclosure, if a volume level of mixing waveforms information changes, an image may be generated by reflecting the changed volume level. For example, as illustrated in FIG. 9, based on relative volume level of a dog sound and a wind sound, an image where a size of a dog and a size of a background are changed may be generated.

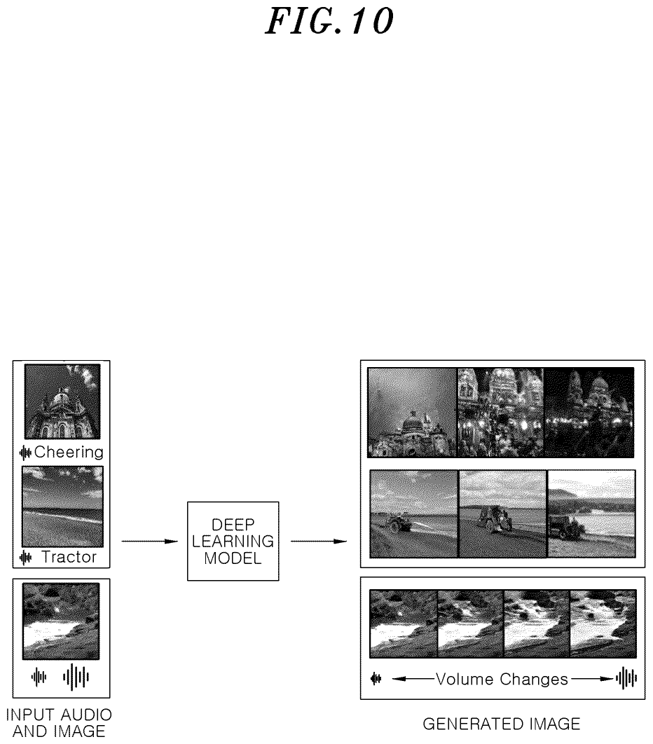

FIG. 10 is a diagram illustrating a various of images generated by a various of audio circumstances according to an embodiment of the present disclosure.

As illustrated in FIG. 10, into an image generating apparatus according to an embodiment of the present disclosure, not only audio information but also image information may be input simultaneously to generate images.

For example, if a building image and a cheering sound are input, a building image with flashing lights may be generated corresponding to the cheering sound. In this case, as illustrated in FIG. 10, for an image of the same building, different images may be generated depending on a type, location, and volume level of the cheering sound.

For another example, if a beach image and a tractor sound are input, an image may be generated by reflecting a tractor image onto the beach image. In this case, as illustrated in FIG. 10, for an image of the same beach, different images may be generated depending on a type, location, and volume level of the tractor sound.

Furthermore, if a volume level of the input audio information changes with respect to the input image information, an image may be generated by reflecting the changed volume level. For example, as illustrated in FIG. 10, if a volume level of an input sound of flowing water changes, an image with changing water currents may be generated by reflecting the changed volume level.

FIG. 11 is a diagram conceptually illustrating a modification of a video by an image generating apparatus by reflecting changes in a volume level of an audio that is input with the video according to an embodiment of the present disclosure.

As illustrated in FIG. 11, a video and an audio may be input into the image generating apparatus according to an embodiment of the present disclosure. In this case, if a volume level of the input audio changes, an image of each frame included in the input video may be generated by reflecting the changed volume level, and a video reflecting the changed volume level may be generated from the generated images. Therefore, by changing the volume level of the input audio, the video may be modified.

FIG. 12 is a diagram specifically illustrating a modification of videos by an image generating apparatus by reflecting changes in a volume level of audios that are input with the videos according to an embodiment of the present disclosure.

As illustrated in FIG. 12 in detail, if the volume level of the input audio changes, the video may be modified by reflecting thereof.

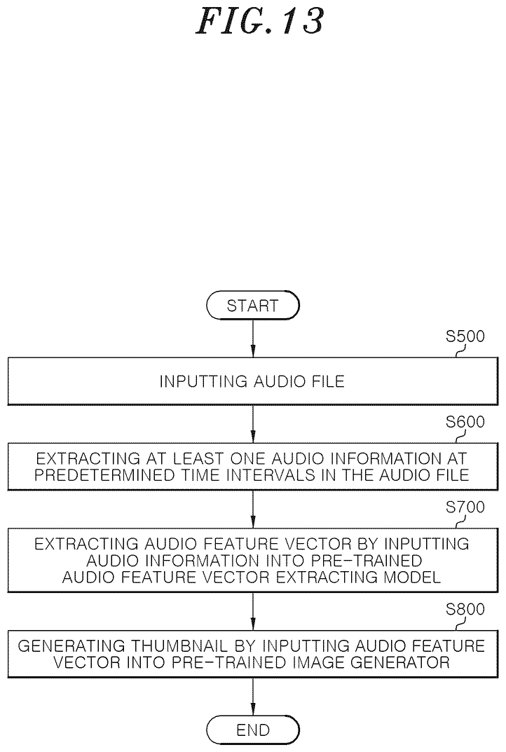

FIG. 13 is a flowchart illustrating a thumbnail generating method according to an embodiment of the present disclosure.

As illustrated in FIG. 13, the thumbnail generating method according to an embodiment of the present disclosure may include a step S500 of inputting an audio file, a step S600 of extracting at least one audio information at predetermined time intervals in the audio file, a step S700 of extracting at least one audio feature vector by inputting the extracted at least one audio information into a pre-trained audio feature vector extracting model, and a step S800 of generating at least one thumbnail by inputting the audio feature vector into an image generator pre-trained to generate an image based on an image feature vector extracted by a pre-trained image feature vector extracting model from image information corresponding to the audio information.

Herein, the audio feature vector may have been aligned within an embedding space with the image feature vector.

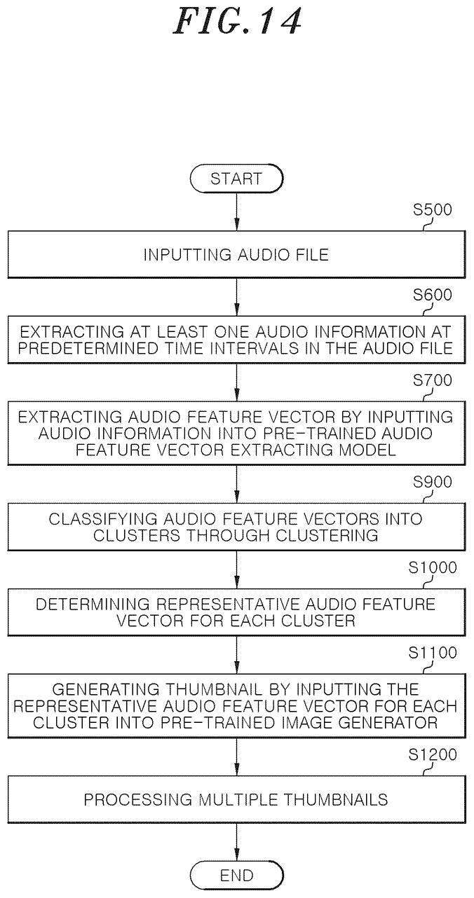

FIG. 14 is a flowchart illustrating a thumbnail generating method according to another embodiment of the present disclosure.

As illustrated in FIG. 14, the thumbnail generating method according to an embodiment of the present disclosure may further include a step S900 of classifying, for the at least one audio feature vector, the audio feature vectors into clusters through clustering, and a step S1000 of determining a representative audio feature vector for each cluster.

Herein, the thumbnail generating method may further include a step S1100 of generating a thumbnail by inputting the representative audio feature vector into the image generator.

If there are a plurality of thumbnails, the thumbnail generating method according to an embodiment of the present disclosure may generate multiple thumbnails and output the generated thumbnails sequentially S1200.

According to another embodiment of the present disclosure, the thumbnail generating method may select a final thumbnail from the generated thumbnails and output the selected final thumbnail.

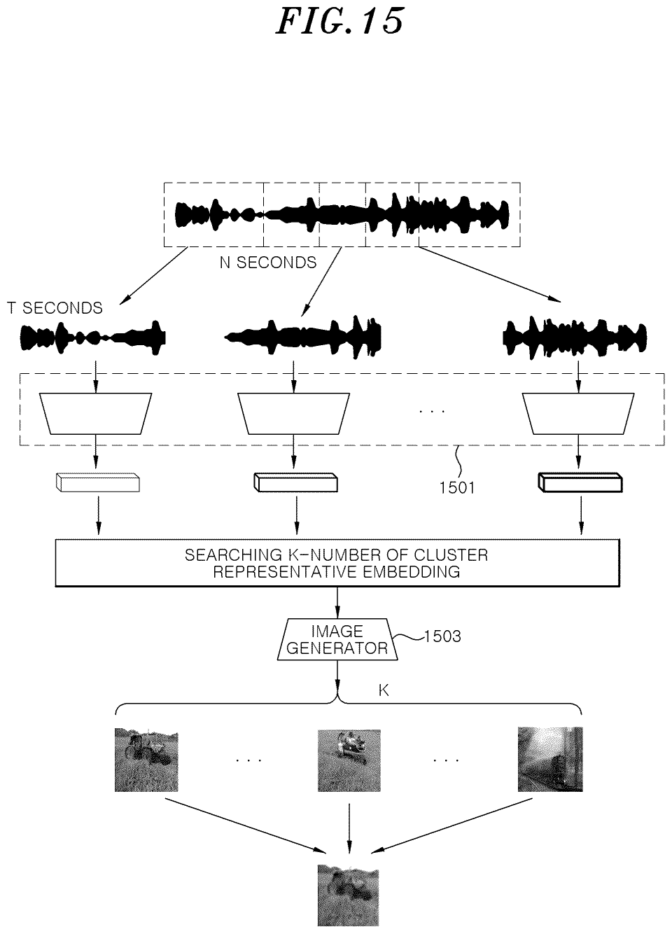

FIG. 15 is a diagram illustrating a thumbnail generating method according to an embodiment of the present disclosure.

First, when receiving an audio file, at least one audio information at intervals of T seconds where adjacent two audio information overlaps for N seconds may be extracted from audio information in the received audio file.

By inputting the extracted at least one audio information into a pre-trained audio feature vector extracting model 1501, at least one audio feature vector may be extracted.

For the extracted at least one audio feature vector, audio feature vectors may be classified into clusters through K-means clustering, and a representative audio feature vector in the cluster may be determined.

By inputting the representative audio feature vector in the cluster into a pre-trained image generator 1503, a thumbnail may be generated.

If there are a plurality of thumbnails, a final thumbnail outputting the generated thumbnails sequentially may be generated. Otherwise, one of the generated thumbnails may be selected as a final thumbnail. At this time, a representative image in the largest cluster may be selected as a final thumbnail.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for training an image generating model that generates an image from an audio, comprising:
selecting at least one frame from a video including a plurality of frames based on a correlation between an audio and an image of each frame;
extracting image information and audio information from each of the selected at least one frame; and
training an audio feature vector extracting model that extracts an audio feature vector from the audio information,
wherein the audio feature vector is aligned within an embedding space with an image feature vector extracted from the image information by a pre-trained image feature vector extracting model.

2. The method of claim 1, wherein the selecting the at least one frame includes selecting the at least one frame from the video using a frame selection method.

3. The method of claim 1, further comprising:
inputting the audio feature vector into an image generator configured to generate the image based on the image feature vector; and
providing the image generated by the image generator.

4. The method of claim 1, wherein the training the audio feature vector extracting model is performed by a contrastive learning method.

5. The method of claim 4, wherein the contrastive learning method includes InfoNCE (noise contrastive estimation).

6. An image generating apparatus comprising:
an input unit configured to receive a first audio;
a memory configured to store computer-executable instructions, an audio feature vector extracting model, an image feature vector extracting model including an image generator; and
a processor configured to execute the one or more instructions stored in the memory, wherein the instructions, when executed by the processor, cause the processor to extract a first audio feature vector from a first audio using the audio feature vector extracting model, and generate a first image based on the first audio feature vector using the image generator,
wherein the audio feature vector extracting model is trained to extract, when at least one frame is selected from a video including a plurality of frames based on a correlation between an audio and an image of each frame, and a second image and a second audio are extracted from each of the selected at least one frame, a second audio feature vector from the second audio,
wherein the second audio feature vector is aligned within an embedding space with a second image feature vector extracted from the second image by a pre-trained image feature vector extracting model, and
wherein the image generator is pre-trained to generate the second image based on the second image feature vector.

7. The image generating apparatus of claim 6, wherein the first audio is different from the second audio.

8. The image generating apparatus of claim 6, wherein the first image is generated, when a volume level of the first audio is changed, by reflecting the changed volume level.

9. The image generating apparatus of claim 6, wherein the input unit is configured to receive the first audio or a third image and input the first audio and the third image to the image generator, and
the image generator is configured to generate a fourth image in which the first image is reflected onto the third image.

10. The image generating apparatus of claim 9, wherein the fourth image is generated by adding a new object corresponding to the first audio onto the third image.

11. The image generating apparatus of claim 9, wherein the fourth image is generated by modifying the third image, corresponding to the first audio.

12. The image generating apparatus of claim 9, wherein the fourth image is generated, when a volume level of the first audio changes, by reflecting the changed volume level.

13. The image generating apparatus of claim 6, wherein the first audio includes a plurality of audio sources originated respectively from a plurality of entities, and
the first image includes each sub-image corresponding to each entity included in the plurality of entities, respectively.

14. The image generating apparatus of claim 13, wherein the first image is generated, when respective volume levels corresponding to a plurality of audio sources included in the first audio relatively is changed to each other, by reflecting the relatively changed respective volume levels.

15. The image generating apparatus of claim 6, wherein the processor is configured to generate a video using a video generator,
wherein the input unit is configured to input the first audio and a first video to the video generator, and
wherein the video generator is configured to generate a second video including a second plurality of images generated by adding a object corresponding to the first audio with a first plurality of images included in the first video.

16. The image generating apparatus of claim 6, wherein the processor is configured to generate a video using a video generator,
wherein the input unit is configured to input the first audio and a first video to the video generator, and
wherein the video generator is configured to generate a second video, if a volume level of the first audio changes, by adding a second plurality of images generated by reflecting the changed volume level with a first plurality of images included in the first video.

17. A non-transitory computer readable storage medium storing computer executable instructions, wherein the instructions, when executed by a processor, cause the processor to perform a thumbnail generating method, the method comprising,
inputting an audio data;
extracting at least one audio information at predetermined time intervals in the audio data;
extracting at least one audio feature vector by inputting the extracted at least one audio information into a pre-trained audio feature vector extracting model; and
generating at least one thumbnail by inputting the audio feature vector into an image generator trained to generate an image based on an image feature vector extracted by a pre-trained image feature vector extracting model from image information corresponding to the audio information,
wherein the audio feature vector is aligned within an embedding space with the image feature vector.

18. The non-transitory computer readable storage medium of claim 17, further comprising:
classifying the at least one audio feature vectors into clusters; and
determining a representative audio feature vector for each cluster,
wherein the generating the thumbnail includes inputting the representative audio feature vector into the image generator and determining the thumbnail generated by the image generator.

19. The non-transitory computer readable storage medium of claim 18, wherein the generating the at least one thumbnail includes generating a plurality of thumbnails and outputting the plurality of generated thumbnails sequentially.

20. The non-transitory computer readable storage medium of claim 18, wherein the generating the at least one thumbnail includes generating a plurality of thumbnails, selecting a final thumbnail from the plurality of generated thumbnails, and outputting a final thumbnail.
